(19) United States
(12) Patent Application Publication
(10) Pub. No.: US 2026/0113093 A1
(43) Pub. Date: Apr. 23, 2026

(54) MACHINE LEARNING-BASED RECEIVER IN WIRELESS COMMUNICATION NETWORK

(71) Applicant: Nokia Solutions and Networks Oy, Espoo (FI)

(72) Inventors: Mikko Johannes HONKALA, Espoo (FI); Janne Matti Juhani HUTTUNEN, Espoo (FI); Antti Herman KOSKELA, Espoo (FI)

(21) Appl. No.: 19/153,445

(22) PCT Filed: Jan. 19, 2024
(86) PCT No.: PCT/EP2024/051227

§ 371 Date: Aug. 4, 2025

(30) Foreign Application Priority Data
Feb. 9, 2023 (FI) 20235131

(51) Int. Cl. H04B 7/06; G06N 3/0464

(52) U.S. Cl. CPC H04B 7/0626; G06N 3/0464

(57) ABSTRACT

The present disclosure relates to a machine learning (ML)-based receiver that is computationally efficient, irrespective of a number N_{R} of receiver antennas used in a Multiple Input Multiple Output (MIMO) scenario. To achieve this, the ML-based receiver is configured to obtain a modified matrix and a modified array of symbols based on a channel state information (CSI) matrix and a received array of symbols. The modified matrix has a dimension N_{T}×N_{T}, where N_{T} is a number of MIMO layers. The modified array of symbols has a dimension N_{T}. After that the ML-based receiver is configured to restore a transmitted array of symbols from the received array of symbols by applying a pre-trained ML model that receives the modified matrix and the modified array of symbols as input data and outputs a set of bit log-likelihood ratio (LLR) estimates for the transmitted array of symbols.

### TECHNICAL FIELD

The present disclosure relates generally to the field of wireless communication. In particular, the present disclosure relates to a machine learning (ML)-based receiver and its operation method in a wireless communication network.

### BACKGROUND

Machine learning (ML)-based receivers have been recently developed, with parts of the ML-based receivers being learned by neural networks (NN). This facilitates improved performance and higher flexibility, as everything is learned directly from input data. A specific implementation of such a receiver is the DeepRx receiver (see Mikko Honkala, et al., “DeepRx: Fully Convolutional Deep Learning Receiver,” IEEE Transactions on Wireless Communications, May 2020, also available in arXiv: 2005.01494). The DeepRx receiver is based on deep convolutional NNs (CNNs), and it achieves high performance in various firth generation (5G) Multiple Input Multiple Output (MIMO) scenarios.

However, an inherent challenge with the existing ML-based receivers, such as the DeepRx receiver, is that while they can provide extremely good radio performance, they also require many computational resources to be run. In particular, the existing ML-based receivers have been found to be particularly difficult to scale to larger, massive MIMO setups.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that allows a number of computational resources used by a ML-based receiver to be minimized in MIMO scenarios.

The objective above is achieved by the features of the independent claims in the appended claims. Further embodiments and examples are apparent from the dependent claims, the detailed description, and the accompanying drawings.

According to a first aspect, an ML-based receiver in a wireless communication network is provided. The ML-based receiver comprises at least one processor and at least one memory storing instructions that, when executed by the at least one processor, cause the ML-based receiver to perform at least as follows. At first, the ML-based receiver receives, by using a plurality of antennas coupled to the ML-based receiver, an array of symbols over a plurality of MIMO layers. The received array of symbols is a distorted version of a transmitted array of symbols and has a dimension N_{R}, where N_{R} is a number of antennas in the plurality of antennas. Then, the ML-based receiver receives, by using the plurality of antennas, a set of reference signals over the plurality of MIMO layers. Next, the ML-based receiver obtains a Channel State Information (CSI) matrix based on the set of reference signals and the received array of symbols. The CSI matrix has a dimension N_{R}×N_{T}, where N_{T} is a number of MIMO layers in the plurality of MIMO layers. Further, the ML-based receiver obtains a modified matrix and a modified array of symbols based on the CSI matrix and the received array of symbols. The modified matrix has a dimension N_{T}×N_{T}, and the modified array of symbols has a dimension N_{T}. After that, the ML-based receiver obtains a set of bit log-likelihood ratio (LLR) estimates for the transmitted array of symbols by using a pre-trained ML model. The pre-trained ML model is configured to: (i) equalize the modified matrix and the modified array of symbols, (ii) refine the equalized modified matrix and the equalized modified array of symbols, and (iii) obtain the set of bit LLR estimates based on the refined modified matrix and the refined modified array of symbols. Thus, in contrast to the existing ML-based receivers (e.g., the DeepRx receiver), the ML-based receiver according to the first aspect operates based on the data representations having dimensions defined only by the number N_{T} of MIMO layers. In other words, the antenna dimension (i.e., N_{R}) is excluded from consideration, meaning that the ML-based receiver according to the first aspect is scaled to setups with a huge number of antennas much better compared to the existing ML-based receivers (e.g., the DeepRx receiver). All of this makes the ML-based receiver according to the first aspect very computationally efficient.

In one example embodiment of the first aspect, the modified matrix is a product of a Hermitian conjugate of the CSI matrix and the CSI matrix, and the modified array of symbols is a product of the Hermitian conjugate of the CSI matrix and the received array of symbols. By using these modifications, the number N_{R} of antennas may be efficiently and quickly eliminated from the dimensions of the CSI matrix and the received array of symbols, while ensuring that the modified matrix is a Hermitian matrix.

In one example embodiment of the first aspect, the pre-trained ML model is configured to perform operations (i) and (ii) on the modified matrix as follows. At first, the ML model applies the equalization operation to an upper triangular part of the modified matrix. Then, the ML model refines the equalized upper triangular part of the modified matrix. After that, the ML model mirrors non-diagonal elements of the refined upper triangular part of the modified matrix to non-diagonal elements of a lower triangular part of the modified matrix. By doing so, it is possible to almost halve the size of the ML model output (and possibly also significantly reduce the size of the ML model itself), thereby additionally reducing the number of computational resources involved in the receiver operation. All of this also enforces the modified matrix to be Hermitian.

In one example embodiment of the first aspect, the pre-trained ML model comprises a convolutional neural network (CNN). By using the CNN, it is possible to perform operations (i)-(iii) more efficiently. It should be also noted that if the equalized modified matrix and the equalized modified array of symbols are refined incrementally in operation (ii), the training of the CNN may be more stable.

In one example embodiment of the first aspect, the CNN is at least one of a depth-wise CNN, a grouped CNN, a recurrent CNN, and a transformer-CNN. By using these CNN types, it is possible to perform operations (i)-(iii) even more efficiently.

In one example embodiment of the first aspect, the CNN is pre-trained by using a stochastic gradient descent (SGD) algorithm. By using the SGD algorithm or its variants (e.g., Adam optimization), the CNN may be trained properly.

In one example embodiment of the first aspect, the CNN comprises a first prediction block and a second prediction block arranged sequentially after the first prediction block in the CNN. The first prediction block is configured to perform operation (i) and obtain a first refinement result for each of the modified matrix and the modified array of symbols during operation (ii). The second prediction block is configured to receive the first refinement result from the first prediction block and obtain, based on the first refinement result, a second refinement result for each of the modified matrix and the modified array of symbols during operation (ii). By using said “residual connection” between the first and second prediction blocks, it is possible to perform operation (ii) more efficiently and accurately.

In one example embodiment of the first aspect, the first prediction block is configured to perform operation (i) by using a linear minimum mean square error (LMMSE)-based equalization. The LMMSE-based equalization may allow the modified matrix and the modified array of symbols to be equalized more efficiently.

In one example embodiment of the first aspect, the second prediction block is further configured to repeat operation (i) before obtaining the second refinement result for each of the modified matrix and the modified array of symbols. By so doing, it is possible to increase the accuracy of obtaining the bit LLR estimates.

In one example embodiment of the first aspect, the second prediction block is configured to perform operation (i) by using an LMMSE-based equalization. The LMMSE-based equalization may allow the modified matrix and the modified array of symbols to be equalized more efficiently.

According to a second aspect, a method for operating a ML-based receiver in a wireless communication network is provided. The method starts with the step of receiving, by using a plurality of antennas coupled to the ML-based receiver, an array of symbols over a plurality of MIMO layers. The received array of symbols is a distorted version of a transmitted array of symbols and has a dimension N_{R}, where N_{R} is a number of antennas in the plurality of antennas. Then, the method goes on to the step of receiving, by using the plurality of antennas, a set of reference signals over the plurality of MIMO layers. Next, the method proceeds to the step of obtaining a CSI matrix based on the set of reference signals and the received array of symbols. The CSI matrix has a dimension N_{R}×N_{T}, where N_{T} is a number of MIMO layers in the plurality of MIMO layers. Further, the method proceeds to the step of obtaining a modified matrix and a modified array of symbols based on the CSI matrix and the received array of symbols. The modified matrix has a dimension N_{T}×N_{T}, and the modified array of symbols has a dimension N_{T}. After that, the method goes on to the step of obtaining a set of bit LLR estimates for the transmitted array of symbols by using a pre-trained ML model. The pre-trained ML model is configured to: (i) equalize the modified matrix and the modified array of symbols, (ii) refine the equalized modified matrix and the modified array of symbols, and (iii) obtain the set of bit LLR estimates based on the refined modified matrix and the refined modified array of symbols. Thus, the operation of the ML-based receiver is based on using the data representations having dimensions defined only by the number N_{T} of MIMO layers. In other words, the antenna dimension (i.e., N_{R}) is excluded from consideration, meaning that the ML-based receiver is scaled to setups with a huge number of antennas much better compared to its prior art analogues (e.g., the DeepRx receiver). All of this makes the ML-based receiver very computationally efficient.

In one example embodiment of the second aspect, the modified matrix is a product of a Hermitian conjugate of the CSI matrix and the CSI matrix, and the modified array of symbols is a product of the Hermitian conjugate of the CSI matrix and the received array of symbols. By using these modifications, the number N_{R} of antennas may be efficiently and quickly eliminated from the dimensions of the CSI matrix and the received array of symbols, while ensuring that the modified matrix is a Hermitian matrix.

In one example embodiment of the second aspect, the pre-trained ML model is configured to perform operations (i) and (ii) on the modified matrix as follows. At first, the ML model applies the equalization operation to an upper triangular part of the modified matrix. Then, the ML model refines the equalized upper triangular part of the modified matrix. After that, the ML model mirrors non-diagonal elements of the refined upper triangular part of the modified matrix to non-diagonal elements of a lower triangular part of the modified matrix. By doing so, it is possible to almost halve the size of the ML model output (and possibly also significantly reduce the size of the ML model itself), thereby additionally reducing the number of computational resources involved in the receiver operation. All of this also enforces the modified matrix to be Hermitian.

In one example embodiment of the second aspect, the ML model comprises a CNN. By using the CNN, it is possible to obtain perform operations (i)-(iii) more efficiently. It should be also noted that if the equalized modified matrix and the equalized modified array of symbols are refined incrementally in operation (ii), the training of the CNN may be more stable.

In one example embodiment of the second aspect, the CNN is at least one of a depth-wise CNN, a grouped CNN, a recurrent CNN, and a transformer-CNN. By using these CNN types, it is possible to perform operations (i)-(iii) even more efficiently.

In one example embodiment of the second aspect, the CNN is pre-trained by using an SGD algorithm. By using the SGD algorithm or its variants (e.g., Adam optimization), the CNN may be trained properly.

In one example embodiment of the second aspect, the CNN comprises a first prediction block and a second prediction block arranged sequentially after the first prediction block in the CNN. The first prediction block is configured to perform operation (i) and obtain a first refinement result for each of the modified matrix and the modified array of symbols during operation (ii). The second prediction block is configured to receive the first refinement result from the first prediction block and obtain, based on the first refinement result, a second refinement result for each of the modified matrix and the modified array of symbols during operation (ii). By using said “residual connection” between the first and second prediction blocks, it is possible to perform operation (ii) more efficiently and accurately.

In one example embodiment of the second aspect, the first prediction block is configured to perform operation (i) by using an LMMSE-based equalization. The LMMSE-based equalization may allow the modified matrix and the modified array of symbols to be equalized more efficiently.

In one example embodiment of the second aspect, the second prediction block is further configured to repeat operation (i) before obtaining the second refinement result for each of the modified matrix and the modified array of symbols. By so doing, it is possible to increase the accuracy of obtaining the bit LLR estimates.

In one example embodiment of the second aspect, the second prediction block is configured to perform operation (i) by using an LMMSE-based equalization. The LMMSE-based equalization may allow the modified matrix and the modified array of symbols to be equalized more efficiently.

According to a third aspect, a computer program product is provided. The computer program product comprises a computer-readable storage medium that stores a computer code. Being executed by at least one processor, the computer code causes the at least one processor to perform the method according to the second aspect. By using such a computer program product, it is possible to simplify the implementation of the method according to the second aspect in any ML-based receiver, like the ML-based receiver according to the first aspect.

According to a fourth aspect, an ML-based receiver in a wireless communication network is provided. The ML-based receiver comprises a means for receiving, by using a plurality of antennas coupled to the ML-based receiver, an array of symbols over a plurality of MIMO layers. The received array of symbols is a distorted version of a transmitted array of symbols and has a dimension N_{R}, where N_{R} is a number of antennas in the plurality of antennas. The ML-based receiver further comprises a means for receiving, by using the plurality of antennas, a set of reference signals over the plurality of MIMO layers. The ML-based receiver further comprises a means for obtaining a CSI matrix based on the set of reference signals and the received array of symbols. The CSI matrix has a dimension N_{R}×N_{T}, where N_{T} is a number of MIMO layers in the plurality of MIMO layers. The ML-based receiver further comprises a means for obtaining a modified matrix and a modified array of symbols based on the CSI matrix and the received array of symbols. The modified matrix has a dimension N_{T}×N_{T}, and the modified array of symbols has a dimension N_{T}. The ML-based receiver further comprises a means for obtaining a set of bit LLR estimates for the transmitted array of symbols by using a pre-trained ML model. The pre-trained ML model is configured to: (i) equalize the modified matrix and the modified array of symbols, (ii) refine the equalized modified matrix and the equalized modified array of symbols, and (iii) obtain the set of bit LLR estimates based on the refined modified matrix and the refined modified array of symbols. Thus, in contrast to the existing ML-based receivers (e.g., the DeepRx receiver), the ML-based receiver according to the first aspect operates based on the data representations having dimensions defined only by the number N_{T} of MIMO layers. In other words, the antenna dimension (i.e., N_{R}) is excluded from consideration, meaning that the ML-based receiver according to the first aspect is scaled to setups with a huge number of antennas much better compared to the existing ML-based receivers (e.g., the DeepRx receiver). All of this makes the ML-based receiver according to the first aspect very computationally efficient.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a block diagram of a machine learning (ML)-based receiver (i.e., the DeepRx receiver) in accordance with the prior art;

FIG. 2 shows a block diagram of a ML-based receiver in accordance with one example embodiment;

FIG. 3 shows a flowchart of a method for operating the ML-based receiver of FIG. 2 in accordance with one example embodiment;

FIG. 4 shows a block diagram of a processor that may be included in the ML-based receiver of FIG. 2 in accordance with a first example embodiment;

FIG. 5 explains the calculations performed inside a first prediction block included in the processor of FIG. 4; and

FIG. 6 shows a block diagram of a processor that may be included in the ML-based receiver of FIG. 2 in accordance with a second example embodiment.

### DETAILED DESCRIPTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatus and method disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment recited herein as “example embodiment” should not be construed as preferable or having an advantage over other embodiments.

According to the example embodiments disclosed herein, a User Equipment (UE) may refer to an electronic computing device that is configured to perform wireless communications. The UE may be implemented as a mobile station, a mobile terminal, a mobile subscriber unit, a mobile phone, a cellular phone, a smart phone, a cordless phone, a personal digital assistant (PDA), a wireless communication device, a desktop computer, a laptop computer, a tablet computer, a gaming device, a netbook, a smartbook, an ultrabook, a medical mobile device or equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IoT) device, an Industrial IoT (IIoT) device, a machine-type communication (MTC) device, a group of Massive IoT (MIoT) or Massive MTC (mMTC) devices/sensors, or any other suitable mobile device configured to support wireless communications. In some embodiments, the UE may refer to at least two collocated and inter-connected UEs thus defined.

As used in the example embodiments disclosed herein, a network node may refer to a fixed point of communication/communication node for a UE in a particular wireless communication network. More specifically, the network node may be used to connect the UE to a Data Network (DN) through a Core Network (CN) and may be referred to as a base transceiver station (BTS) in terms of the 2G communication technology, a NodeB in terms of the 3G communication technology, an evolved NodeB (eNodeB or eNB) in terms of the 4G communication technology, and a gNB in terms of the 5G New Radio (N_{R}) communication technology. The network node may serve different cells, such as a macrocell, a microcell, a picocell, a femtocell, and/or other types of cells. The macrocell may cover a relatively large geographic area (e.g., at least several kilometers in radius). The microcell may cover a geographic area less than two kilometers in radius, for example. The picocell may cover a relatively small geographic area, such, for example, as offices, shopping malls, train stations, stock exchanges, etc. The femtocell may cover an even smaller geographic area (e.g., a home). Correspondingly, the network node serving the macrocell may be referred to as a macro node, the network node serving the microcell may be referred to as a micro node, and so on.

According to the example embodiments disclosed herein, a wireless communication network, in which a UE and a network node communicate with each other, may refer to a cellular or mobile network, a Wireless Local Area Network (WLAN), a Wireless Personal Area Networks (WPAN), a Wireless Wide Area Network (WWAN), a satellite communication (SATCOM) system, or any other type of wireless communication networks. Each of these types of wireless communication networks supports wireless communications according to one or more communication protocol standards. For example, the cellular network may operate according to the Global System for Mobile Communications (GSM) standard, the Code-Division Multiple Access (CDMA) standard, the Wide-Band Code-Division Multiple Access (WCDM) standard, the Time-Division Multiple Access (TDMA) standard, or any other communication protocol standard, the WLAN may operate according to one or more versions of the IEEE 802.11 standards, the WPAN may operate according to the Infrared Data Association (IrDA), Wireless USB, Bluetooth, or ZigBee standard, and the WWAN may operate according to the Worldwide Interoperability for Microwave Access (WiMAX) standard.

Data transmission between UEs, between network nodes, or between UEs and network nodes may be performed using a MIMO technology. The MIMO technology involves employing multiple transmit antennas at a transmitting entity (e.g., a UE or network node) and multiple receive antennas at a receiving entity (e.g., another UE or network node) for data transmission. A MIMO channel formed by the transmit antennas and receive antennas may be decomposed into spatial layers (also known as MIMO layers). The MIMO layers may be used to transmit data in parallel to achieve higher throughput and/or redundantly to achieve greater reliability. The MIMO layers may experience various deleterious channel conditions (e.g., fading, multipath, interference effects, etc.), for which reason they may achieve different signal-to-noise-and-interference ratios (SNRs). The SNR of each MIMO layer determines its transmission capacity, which is typically quantified by a particular data rate that may be reliably transmitted on the MIMO layer. For a time-varying wireless channel, the channel conditions change over time and the SNR of each MIMO layer also changes over time. The different SNRs of the MIMO layers plus the time-varying nature of the SNR for each MIMO layer make it challenging to efficiently transmit data in a MIMO system.

ML-based receivers have been recently developed, which allow transmitted data in MIMO systems to be efficiently and reliably restored or decoded at the receiving entity. More specifically, the ML-based receivers are configured to predict probability estimates (e.g., bit log likelihood ratios (LLRs)) for the transmitted data by using a ML model (e.g., neural network).

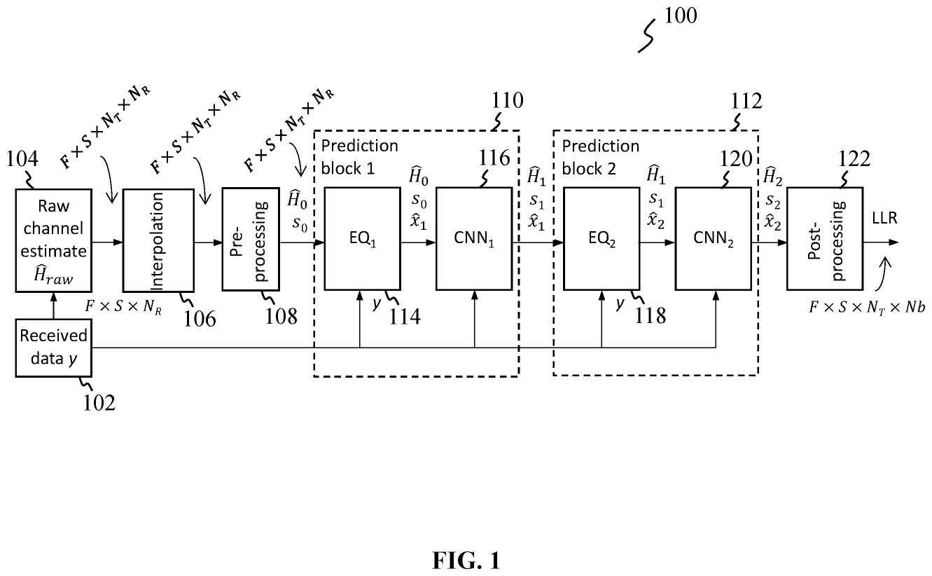

FIG. 1 shows a block diagram of a ML-based receiver 100 in accordance with the prior art. In particular, the ML-based receiver 100 corresponds to the DeepRx receiver. The ML-based receiver 100 comprises a block 102 for receiving an array of data or symbols which may be expressed as follows:

$$y = \hat{H} x + n ,$$

where y is the received array of data, y∈ [symbol] , F is the number of subcarriers, S is the number of symbols (typically 14 in 5G systems) carrying pilots, N_{R} is the number of receiver antennas (which may be part of or coupled to the ML-based receiver 100), Ĥ is the CSI matrix, Ĥ∈ [symbol] , N_{T} is the number of MIMO layers, x is the transmitted array of data, and n is the noise-plus-interference signal. Thus, one can consider y as a distorted (e.g., due to noise) version of x.

The ML-based receiver 100 further comprises a block 104 for receiving reference or pilot signals and using them together with y to obtain the CSI matrix Ĥ. The CSI matrix Ĥ is further subjected to the nearest neighbor interpolation in a next block 106. Next, a ML-based pre-processing block 108 is used, which is responsible for processing the CSI matrix Ĥ and outputting its refined version Ĥ₀ and a hidden state so. It should be noted that a hidden state is a variable in a ML model which allows the ML model to transfer data in learned format. The pre-processing block 108 may be implemented as a CNN (e.g., Residual CNN).

After the pre-processing block 108, two prediction blocks 110 and 112 are arranged in sequence. The first prediction block 110 comprises a first equalization block 114 and a first CNN 116, and the second prediction block 112 comprises a second equalization block 118 and a second CNN 120. The first equalization block 114 performs an equalization operation (e.g., LMMSE) based on Ĥ₀, s₀ and y to obtain an estimate \hat{x}1 for the transmitted array of data, i.e., x. The first CNN 116 uses Ĥ₀, s₀, y and \hat{x}₁ as input data and outputs \hat{x}₁ together with next refined versions of the CSI matrix and the hidden state, i.e., Ĥ₁ and s₁. The second equalization block 118 performs an equalization operation (e.g., LMMSE) based on Ĥ₁, s₁, \hat{x}₁ and y to obtain a refined estimate \hat{x}₂ for x. The second CNN 120 uses Ĥ₁, s₁, y and \hat{x}₂ as input data and outputs \hat{x}₂ together with next refined versions of the CSI matrix and the hidden state, i.e., Ĥ₂ and s₂. It should be noted that there may be more than two prediction blocks in the ML-based receiver 100—in general, the number of prediction blocks depends on the accuracy with which it is required to obtain the final result.

The ML-based receiver 100 further comprises a post-processing block 122 for obtaining bit LLRs for x based on Ĥ₂, s₂ and \hat{x}₂. More specifically, the block 122 outputs the array of bit LLRs L∈ [symbol] , where N_{b} is the number of bits.

The ML-based receiver 100 is computationally efficient for small MIMO setups (with a small number of receiver antennas). However, it does not scale well for massive MIMO setups (with a huge number of receiver antennas, such as 128-1024). This is because each prediction block deals with the full CSI matrix which has dimensions defined by both N_{T} and N_{R}, leading to

$$O ( {N}_{T}^{2} {N}_{R}^{2} )$$

type of complexity in the execution of the CNNs. Furthermore, the ML-based receiver 100 scales unfavorably in terms of compute complexity when the number of receiver antennas is increased, e.g., for massive MIMO.

The example embodiments disclosed herein provide a technical solution that allows mitigating or even eliminating the above-sounded drawbacks peculiar to the prior art. In particular, the technical solution disclosed herein relates to a ML-based receiver that is computationally efficient irrespective of the number N_{R} of receiver antennas used in a MIMO scenario. To achieve this, the ML-based receiver is configured to obtain a modified matrix and a modified array of symbols based on a CSI matrix and a received array of symbols. The modified matrix has a dimension N_{T}×N_{T}, and the modified array of symbols has a dimension N_{T}, i.e., they are both independent of N_{R}. After that, the ML-based receiver is configured to restore a transmitted array of symbols from the received array of symbols by applying a pre-trained ML model that receives the modified matrix and the modified array of symbols as input data and outputs a set of bit LLR estimates for the transmitted array of symbols. The ML-based receiver thus configured allows for proper scaling to massive MIMO setups, may reach state-of-the-art radio performance, with a large margin compared to the existing ML-based receivers (e.g., the DeepRx receiver).

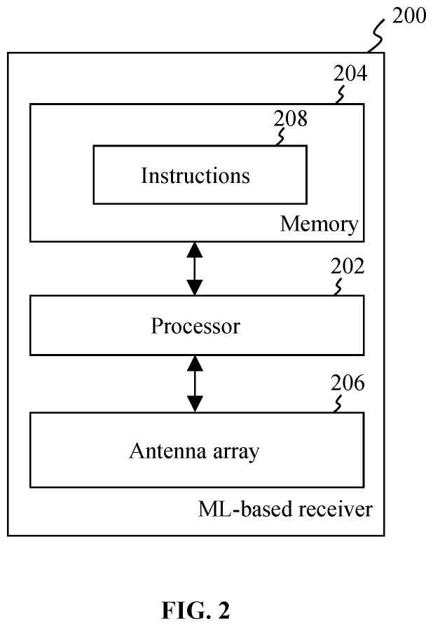

FIG. 2 shows a block diagram of a ML-based receiver 200 in accordance with one example embodiment. The ML-based receiver 200 is intended to be part of a UE or a network node in a wireless communication network. As shown in FIG. 2, the ML-based receiver 200 comprises a processor 202, a memory 204, and an antenna array 206. The memory 204 stores processor-executable instructions 208 which, when executed by the processor 202, cause the processor 202 to perform the aspects of the present disclosure, as will be described below in more detail.

It should be noted that the number, arrangement, and interconnection of the constructive elements constituting the ML-based receiver 200, which are shown in FIG. 2, are not intended to be any limitation of the present disclosure, but merely used to provide a general idea of how the constructive elements may be implemented within the ML-based receiver 200. For example, the processor 202 may be replaced with several processors, as well as the memory 204 may be replaced with several removable and/or fixed storage devices, depending on particular applications. Furthermore, in some embodiments, the antenna array 206 may be not part of the ML-based receiver 200—i.e., the ML-based receiver 200 may be coupled to one or more external antenna arrays. On top of that, it is assumed that the processor 202 is capable of performing different operations required to perform the data reception and transmission, such, for example, as signal modulation/demodulation, encoding/decoding, etc.

The processor 202 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 202 may be implemented as any combination of one or more of the aforesaid. As an example, the processor 202 may be a combination of two or more microprocessors.

The memory 204 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 208 stored in the memory 204 may be configured as a computer-executable program code which causes the processor 202 to perform the aspects of the present disclosure. The computer-executable program code for carrying out operations or steps for the aspects of the present disclosure may be written in any combination of one or more programming languages, such as Java, C++, or the like. In some examples, the computer-executable program code may be in the form of a high-level language or in a pre-compiled form and be generated by an interpreter (also pre-stored in the memory 204) on the fly.

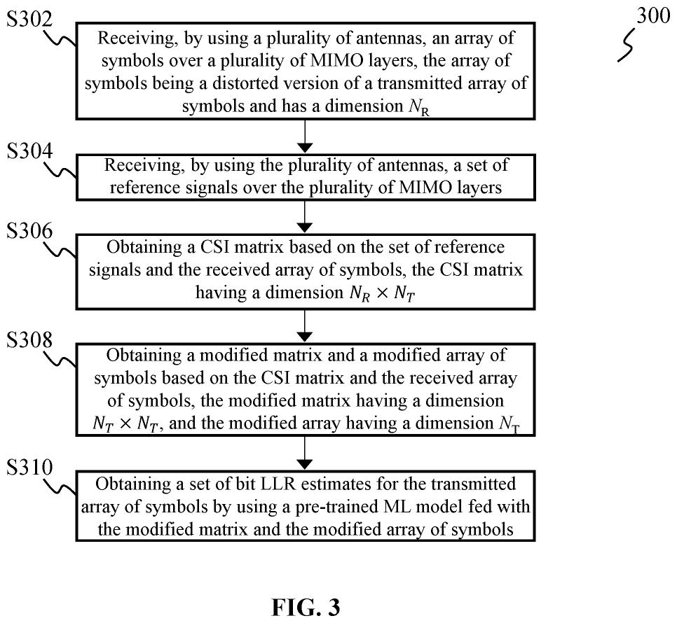

FIG. 3 shows a flowchart of a method 300 for operating the ML-based receiver 200 in accordance with one example embodiment. The method 300 starts with a step S302, in which the processor 202 receives, by using the antenna array 206, an array of (data) symbols over a plurality of MIMO layers. As noted earlier, the received array of symbols is a distorted version of a transmitted array of symbols due to the fact the MIMO layers are noisy. The received array of symbols has a dimension N_{R} which is a number of antennas in the antenna array 206. Then, the method 300 goes on to a step S304, in which the processor 202 receives, by using the antenna array 206, a set of reference or pilot signals over the plurality of MIMO layers. Next, the method 300 proceeds to a step S306, in which the processor 202 obtains a CSI matrix based on the set of reference signals and the received array of symbols. For example, the CSI matrix may be obtained by calculating the conjugate multiplication of the received array of symbols by the set of reference signals and then by interpolating the result of the multiplication using a proper interpolation algorithm (e.g., nearest neighbor interpolation). The CSI matrix thus obtained has a dimension defined by N_{R} and a number N_{T} of MIMO layers in the plurality of MIMO layers, i.e., N_{R}×N_{T}.

Further, the method 300 proceeds to a step S308, in which the processor 202 obtains a modified matrix and a modified array of symbols based on the CSI matrix and the received array of symbols. The modified matrix has a dimension N_{T}×N_{T}, and the modified array of symbols has a dimension N_{T}. For example, the modified matrix and the modified array of symbols may be obtained by using the following equations:

$$\begin{matrix}\hat{A} = {\hat{H}}^{H} \hat{H} ∈ , \\ \tilde{z} = {\hat{H}}^{H} y ∈ ,\end{matrix}$$

where Ĥ∈ [symbol] is the CSI matrix, Ĥ^{H} is the Hermitian conjugate of the CSI matrix, y is the received array of symbols, Â is the modified matrix, and \tilde{z} is the modified array of symbols.

In other embodiments, the modified matrix and the modified array of symbols may be obtained in the form of decomposed matrices in some decomposition (e.g., QR decomposition).

It should be noted that the dimension N_{T} (i.e., the number of MIMO layers) is usually small especially compared to the number of antennas, i.e., N_{R}. Therefore, Â and \tilde{z} obtained in the step S308 may (but not necessarily) have lower dimensions compared to the CSI matrix and the received array of symbols, respectively. In one other embodiment, Â may be further substituted with

$$\frac{\hat{A} + {\hat{A}}^{H}}{2} ,$$

where Â^{H} is the Hermitian conjugate of Â.

After the step S308, the method goes on to a step S310, in which the processor 202 obtains a set of bit LLR estimates for the transmitted array of symbols by using a pre-trained ML model. The pre-trained ML model is configured to: (i) apply an equalization operation to the modified matrix and the modified array of symbols, (ii) (incrementally) refine (e.g., by using the loss function which will be described below) the equalized modified matrix and the modified array of symbols, and (iii) obtain the set of bit LLR estimates based on the refined modified matrix and the refined modified array of symbols. The equalization operation may be an LMMSE equalization defined as

$$\hat{x} = {( {\hat{H}}^{H} \hat{H} + {σ}_{w}^{2} I )}^{- 1} {\hat{H}}^{H} y ,$$

where x is the estimate for the transmitted array of symbols to be restored in the ML-receiver 200, I is the identity matrix, and

$${σ}_{w}^{2}$$

is the noise power estimate. For example,

$${σ}_{w}^{2} I$$

may be set to be diagonal with the value of 0.01. By using Â and \tilde{z}, the above equation can be rewritten as

$$\hat{x} = {( \hat{A} + {σ}_{w}^{2} I )}^{- 1} \tilde{z} .$$

In one embodiment, the processor 202 may use the Neumann series approximation to approximate inversion in the LMMSE equalization (see, e.g., M. Wu, B. Yin, A. Vosoughi, C. Studer, J. R. Cavallaro, and C. Dick, “Approximate matrix inversion for high-throughput data detection in the large-scale MIMO uplink,” in 2013 IEEE International Symposium on Circuits and Systems (ISCAS), 2013, pp. 2155-2158), namely:

$$\begin{matrix}A = D + E as \\ {A}^{- 1} = {( D + E )}^{- 1} = {\sum }_{n = 0}^{∞} {( - {D}^{- 1} E )}^{n} {D}^{- 1} ,\end{matrix}$$

where the matrix A is decomposed into its main diagonal matrix D and its off-diagonal matrix E.

As for the ML model used in the step S310, it can be implemented as a depth-wise CNN, a grouped CNN, a recurrent CNN, a transformer-CNN, or any combination thereof. The training of these CNNs may be performed using a stochastic gradient descent (SGD) algorithm or its variants (e.g., Adam optimization). At the same time, the present disclosure is not limited to these CNNs; in some embodiments, the ML model may be represented by properly configured other types of NNs, decision trees, etc.

In one embodiment, if the modified matrix is a Hermitian matrix, the ML model may be configured to perform operations (i) and (ii) on the modified matrix as follows. At first, the ML model applies the equalization operation to an upper triangular part of the modified matrix. Then, the ML model (incrementally) refines the equalized upper triangular part of the modified matrix. After that, the ML model mirrors non-diagonal elements of the refined upper triangular part of the modified matrix to non-diagonal elements of a lower triangular part of the modified matrix.

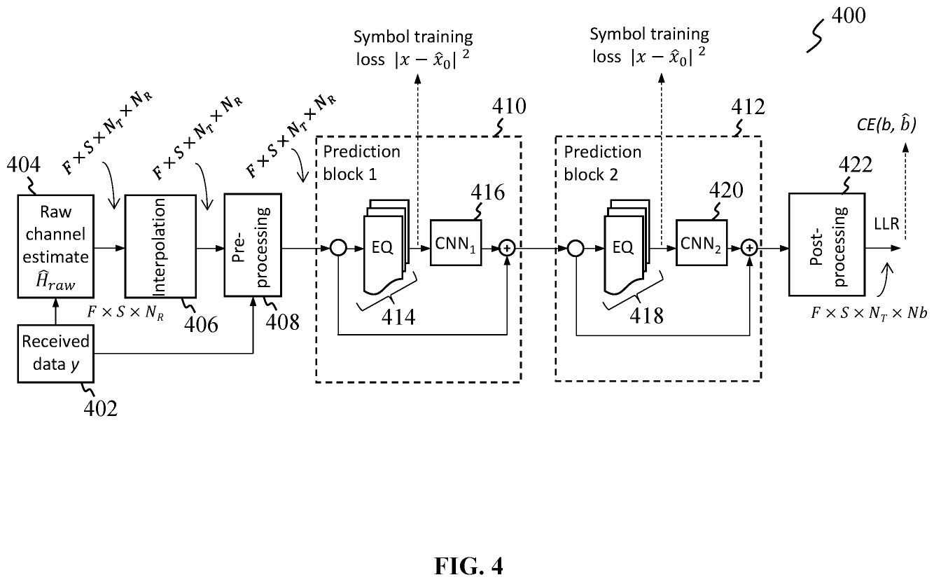

Let us now describe the above-indicated mirroring from the mathematical standpoint. Assuming that Â is a complex-valued matrix of size n×n. If the ML model outputs the n diagonal elements of Â in the form of a diagonal n×n matrix D and the strictly (i.e., non-diagonal) upper-triangular elements Âᵢⱼ, j>i, in the form of an n×n matrix E, full Â can be obtained simply by computing Â=D+E+E^{H}, where E^{H} is the Hermitian conjugate of E. FIG. 4 shows a block diagram of a processor 400 that may be included (as the processor 202) in the ML-based receiver 200 in accordance with a first example embodiment. The input processing performed by blocks 402, 404 and 406 of the processor 400 is similar to that of the blocks 102, 104, and 106, respectively. More specifically, the block 402 is configured to receive (in the step S302) the array of symbols over the plurality of MIMO layers, the block 404 is configured to receive (in the step S304) the set of reference or pilot signals over the plurality of MIMO layers and use them together with the received array of symbols to obtain (in the step S306) the CSI matrix, and the (optional) block 406 is configured to apply the nearest neighbor interpolation to the CSI matrix (instead of the nearest neighbor interpolation, bilinear interpolation may be used, or a pre-trained neural network configured to perform a required interpolation may be used).

As for a pre-processing block 408, it operates differently compared to the pre-processing block 108. The pre-processing block 408 is configured to perform the above-indicated modification in the step S308, i.e., obtain the modified matrix and the modified array of symbols (e.g., in the form of A and z, respectively). It should be noted that the pre-processing block 408 may be implemented as part of the ML model itself (e.g., CNN).

As also shown in FIG. 4, the processor 400 comprises two successive prediction blocks 410 and 412. The prediction block 410 comprises at least one first equalization block 414 and a first CNN 416, and the prediction block 412 comprises at least one second equalization block 418 and a second CNN 420. The first equalization block(s) 414 and the second equalization block(s) 418 may apply the same equalization operation (e.g., the LMMSE equalization discussed above) to obtain the LLR estimates for the transmitted array of symbols. The CNNs 416 and 420 are configured to incrementally refine the equalized modified matrix and modified array of symbols. The CNNs 416 and 420 may share at least some weights, for which reason the ML-based receiver 200 may be closer to an iterative receiver. The output (i.e., the fully refined modified matrix and modified array of symbols, as well as the LLR estimates for the transmitted array of symbols) of the second prediction block 412 is provided to a post-processing block 422. The post-processing block 422 may also comprise at least one additional equalization block configured to additionally equalize the LLR estimates for the transmitted array of symbols and a mapping block configured to map the equalized LLR estimates for the transmitted array of symbols to a set of bit LLRs. The step S310 is implemented due to the joint operation of the prediction blocks 410, 412 and the post-processing block 422.

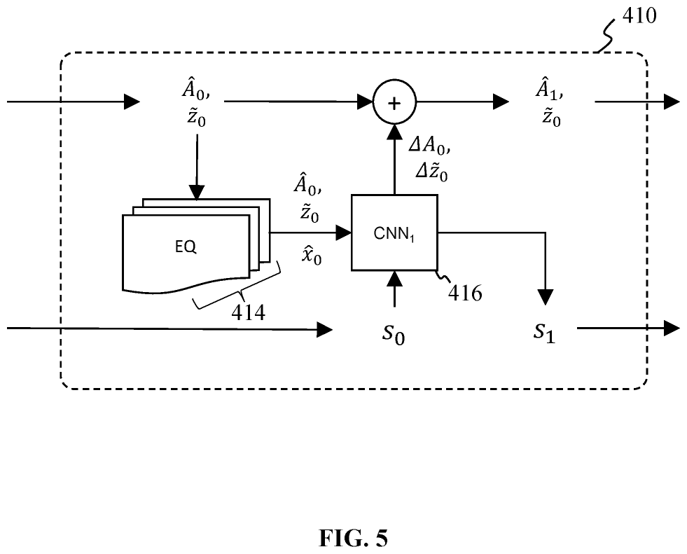

In some embodiments, the number of prediction blocks in the processor 202 may be more than 2, depending on the accuracy with which one can obtain the set of bit LLR estimates for the transmitted array of symbols. In other embodiments, only the first prediction block may be provided with the equalization block(s); the rest prediction blocks may comprise CNNs only. In some other embodiments, the blocks 408, 422 and the prediction blocks 410, 412 may constitute a single CNN (e.g., by combining ResNet blocks similarly as proposed in the following document: Mikko Honkala, et al., “DeepRx: Fully Convolutional Deep Learning Receiver,” IEEE Transactions on Wireless Communications, May 2020, also available in arXiv: 2005.01494). In yet another embodiment, the processor 400 may comprise an additional beamforming block before the pre-processing block 408, and the beamforming block may be configured to implement different beamforming schemes, such as eigen-beamforming, thereby providing a further reduction in the computational cost of the ML-based receiver 200. FIG. 5 explains the calculations performed in the first prediction block 410 included in the processor 400. Before the first prediction block 410, Â₀ and \tilde{z}₀ are computed by the pre-processing block 408 from A and y using the equations above. Then, in the first prediction block 410, Â₀ and \tilde{z}₀ are fed to the first equalization block(s) 414 which, for example, may employ the LMMSE equalization. The first equalization block(s) form the estimate \hat{x}₀ of transmitted symbols and feeds it to the first CNN 416 (e.g., in the form of trained ResNet blocks) together with Ã₀, \tilde{z}₀, and so to form Â₁, \tilde{z}₁, and s₁. The same procedure is repeated in the following second prediction block 412. Finally, the last estimate \tilde{x}₂, together with s₂, is fed to the post-processing block 422 (e.g., in the form of trained ResNet blocks), which outputs the bit LLRs.

There are two notable additional ingredients to be used in the above calculations, namely:
1. The pre-processing block 408 is further configured to output the hidden state so which is fed to the CNN 416 in the prediction block 410. Then, the CNN 416 outputs the next hidden state s₁ which, in turn, is fed to the CNN 420 in the next prediction block 412. If the number of prediction blocks is more than 2, this is repeated for all the blocks. Such mechanism allows information transfer between the CNNs.
2. Every prediction block improves the estimate \hat{z}ₙ by using the previous estimate of Â and \tilde{z}. However, the estimate \hat{x}ₙ does not necessarily need to be the transmitted symbols if those are only processed using the trained components. Therefore, a specific setup is used, where during training, each prediction block is penalized for |x−\hat{x}ₙ|². In other words, the terms |x−\hat{x}ₙ|² are added to training losses. This aids the ML-based model to form the output of layers that are similar to the true (transmitted) symbols.

It should be also noted that every CNN of the prediction blocks 410, 412 estimates the delta to the previous estimates of Â and \tilde{z}, instead of completely new values of them. This can make the training of the CNNs more stable.

The training of the CNN of each prediction block may be performed using the SGD algorithm or its variants (e.g., Adam optimization). In this case, it is possible to use a loss function that contains a binary cross entropy (CE) calculated at the output of the ML-based receiver 200, as well as MSE losses from the prediction block outputs. The CE for the output of the ML-based receiver 200 may be written as:

$$CE ( b , \hat{b} ) = - \frac{1}{\# DB} {\sum }_{( i , j ) ∈ D} {\sum }_{l = 0}^{B - 1} ( {b}_{ijl} log {\hat{b}}_{ijl} + ( 1 - {b}_{ijl} ) log ( 1 - {\hat{b}}_{ijl} ) ) ,$$

where D is the set of indices corresponding to resource elements carrying data, #D is the number of such indices, B is the number of samples in the sample batch, and \hat{b}ᵢⱼₗ are the predicted bit probabilities (\hat{b}ᵢⱼₗ=sigmoid (Lᵢⱼₗ), where Lᵢⱼₗ is the output or LLRs of the ML-based receiver 200). The MSE losses may be written as

$$MSE ( x , {\hat{x}}_{n} ) = {\vert x - {\hat{x}}_{n} \vert}^{2} .$$

The total loss is the sum of the above,

$$L = CE + {α}_{1} MSE ( x , {\hat{x}}_{1} ) + … + {α}_{N} MSE ( x , {\hat{x}}_{n} )$$

where N is the number of prediction blocks and αᵢ are the weights of the i-th prediction block. The MSE losses are weighted such that the weights of the first prediction blocks are lower, while the weights of the final prediction blocks are higher. This ensures that the ML model is not forced to focus too much on the first prediction blocks where the accuracy is inherently lower (and hence the loss term is larger).

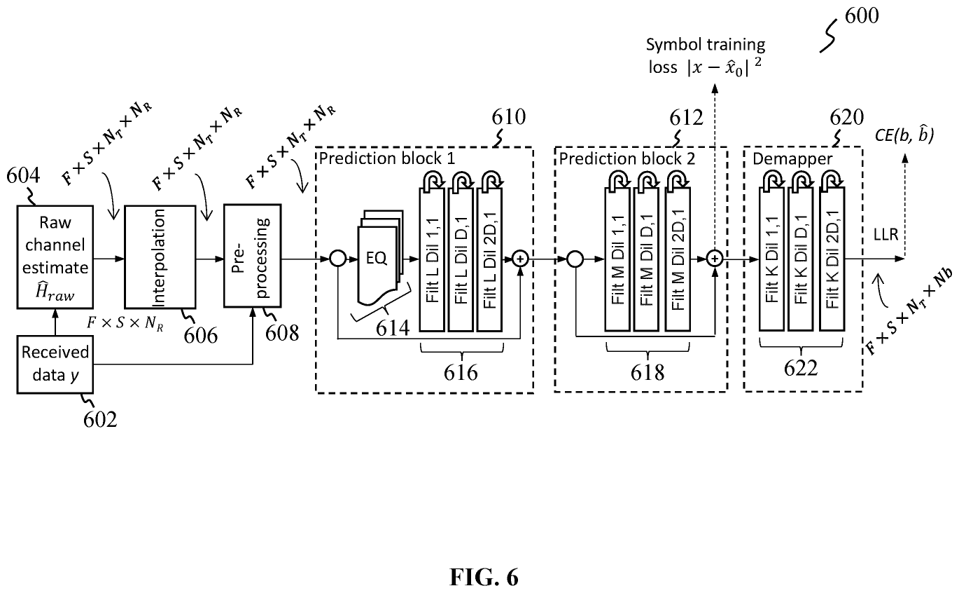

FIG. 6 shows a block diagram of a processor 600 that may be included (as the processor 202) in the ML-based receiver 200 in accordance with a second example embodiment. The input processing performed by blocks 602, 604 and 606 of the processor 600 is similar to that of the blocks 102, 104, and 106, respectively. More specifically, the block 602 is configured to receive (in the step S302) the array of symbols over the plurality of MIMO layers, the block 604 is configured to receive (in the step S304) the set of reference or pilot signals over the plurality of MIMO layers and use them together with the received array of symbols to obtain (in the step S306) the CSI matrix, and the (optional) block 606 is configured to apply, for example, the nearest neighbor interpolation to the CSI matrix.

A pre-processing block 608 is implemented in the same or similar manner as the pre-processing block 408.

As for prediction blocks 610 and 612, they are implemented differently compared to the prediction blocks 410 and 412. More specifically, according to the second embodiment, only the first prediction block 610 is configured to perform an equalization operation (e.g., LMMSE), for which reason it comprises at least one equalization block 614. At the same time, the first and second prediction blocks 610, 612 comprises residual CNNs 616, 618 each implemented as a set of convolutional filters with certain parameters, such as a count of filters L, and M, and a size of dilation D. The processor 600 further comprises a post-processing block implemented as a demapper 620 comprising a residual CNN 622 having a set of convolutional filters with certain parameters, such as a number of filters M and a size of dilation D.

It should be noted that each step or operation of the method 300, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processor 202, 400, or 600. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A machine learning (ML)-based receiver in a wireless communication network, comprising:
at least one processor; and
at least one memory storing instructions that, when executed by the at least one processor, cause the ML-based receiver at least to:
by using a plurality of antennas coupled to the ML-based receiver, receive an array of symbols over a plurality of Multiple Input Multiple Output (MIMO) layers, the received array of symbols being a distorted version of a transmitted array of symbols and having a dimension N_{R}, where N_{R} is a number of antennas in the plurality of antennas;
by using the plurality of antennas, receive a set of reference signals over the plurality of MIMO layers;
obtain a Channel State Information (CSI) matrix based on the set of reference signals and the received array of symbols, the CSI matrix having a dimension N_{R}×N_{T}, where N_{T} is a number of MIMO layers in the plurality of MIMO layers;
obtain a modified matrix and a modified array of symbols based on the CSI matrix and the received array of symbols, the modified matrix having a dimension N_{T}×N_{T}, and the modified array of symbols having a dimension N_{T}; and
obtain a set of bit log-likelihood ratio (LLR) estimates for the transmitted array of symbols by using a pre-trained ML model, wherein the pre-trained ML model is configured to: (i) equalize the modified matrix and the modified array of symbols, (ii) refine the equalized modified matrix and the equalized modified array of symbols, and (iii) obtain the set of bit LLR estimates based on the refined modified matrix and the refined modified array of symbols, wherein
the modified matrix is a product of a Hermitian conjugate of the CSI matrix and the CSI matrix; and
the modified array of symbols is a product of the Hermitian conjugate of the CSI matrix and the received array of symbols.

2. (canceled)

3. The ML-based receiver of claim 1, wherein the pre-trained ML model is configured to perform operations (i) and (ii) on the modified matrix by:
equalizing an upper triangular part of the modified matrix;
refining the equalized upper triangular part of the modified matrix; and
mirroring non-diagonal elements of the refined upper triangular part of the modified matrix to non-diagonal elements of a lower triangular part of the modified matrix.

4. The ML-based receiver of claim 1, wherein the pre-trained ML model comprises a convolutional neural network (CNN).

5. The ML-based receiver of claim 4, wherein the CNN is at least one of a depth-wise CNN, a grouped CNN, a recurrent CNN, and a transformer-CNN.

6. The ML-based receiver of claim 4, wherein the CNN is pre-trained by using a stochastic gradient descent (SGD) algorithm.

7. The ML-based receiver of claim 4, wherein
the CNN comprises a first prediction block and a second prediction block arranged sequentially after the first prediction block in the CNN;
the first prediction block is configured to perform operation (i) and obtain a first refinement result for each of the modified matrix and the modified array of symbols during operation (ii); and
the second prediction block is configured to receive the first refinement result from the first prediction block and obtain, based on the first refinement result, a second refinement result for each of the modified matrix and the modified array of symbols during operation (ii).

8. The ML-based receiver of claim 7, wherein the first prediction block is configured to perform operation (i) by using a linear minimum mean square error (LMMSE)-based equalization.

9. The ML-based receiver of claim 7, wherein the second prediction block is further configured to repeat operation (i) before obtaining the second refinement result for each of the modified matrix and the modified array of symbols.

10. The ML-based receiver of claim 9, wherein the second prediction block is configured to repeat operation (i) by using an LMMSE-based equalization.

11. A method for operating a machine learning (ML)-based receiver in a wireless communication network, comprising:
by using a plurality of antennas coupled to the ML-based receiver, receiving an array of symbols over a plurality of Multiple Input Multiple Output (MIMO) layers, the received array of symbols being a distorted version of a transmitted array of symbols and having a dimension N_{R}, where N_{R} is a number of antennas in the plurality of antennas;
by using the plurality of antennas, receiving a set of reference signals over the plurality of MIMO layers;
obtaining a Channel State Information (CSI) matrix based on the set of reference signals and the received array of symbols, the CSI matrix having a dimension N_{R}×N_{T}, where N_{T} is a number of MIMO layers in the plurality of MIMO layers;
obtaining a modified matrix and a modified array of symbols based on the CSI matrix and the received array of symbols, the modified matrix having a dimension N_{T}×N_{T}, and the modified array of symbols having a dimension N_{T}; and
obtaining a set of bit log-likelihood ratio (LLR) estimates for the transmitted array of symbols by using a pre-trained ML model, wherein the pre-trained ML model is configured to: (i) equalize the modified matrix and the modified array of symbols, (ii) refine the equalized modified matrix and the equalized modified array of symbols, and (iii) obtain the set of bit LLR estimates based on the refined modified matrix and the refined modified array of symbols, wherein
the modified matrix is a product of a Hermitian conjugate of the CSI matrix and the CSI matrix; and
the modified array of symbols is a product of the Hermitian conjugate of the CSI matrix and the received array of symbols.

12. (canceled)

13. The method of claim 11, wherein the pre-trained ML model is configured to perform operations (i) and (ii) on the modified matrix by:
equalizing an upper triangular part of the modified matrix;
refining the equalized upper triangular part of the modified matrix; and
mirroring non-diagonal elements of the refined upper triangular part of the modified matrix to non-diagonal elements of a lower triangular part of the modified matrix.

14. The method of any one of claim 11, wherein the pre-trained ML model comprises a convolutional neural network (CNN).

15. The method of claim 14, wherein the CNN is at least one of a depth-wise CNN, a grouped CNN, a recurrent CNN, and a transformer-CNN.

16. The method of claim 14, wherein the CNN is pre-trained by using a stochastic gradient descent (SGD) algorithm.

17. The method of claim 14, wherein
the CNN comprises a first prediction block and a second prediction block arranged sequentially after the first prediction block;
the first prediction block is configured to perform operation (i) and obtain a first refinement result for each of the modified matrix and the modified array of symbols during operation (ii); and
the second prediction block is configured to receive the first refinement result from the first prediction block and obtain, based on the first refinement result, a second refinement result for each of the modified matrix and the modified array of symbols during operation (ii).

18. The method of claim 17, wherein the first prediction block is configured to perform operation (i) by using a linear minimum mean square error (LMMSE)-based equalization.

19. The method of claim 17, wherein the second prediction block is further configured to repeat operation (i) before obtaining the second refinement result for each of the modified matrix and the modified array of symbols.

20. The method of claim 19, wherein the second prediction block is configured to repeat operation (i) by using an LMMSE-based equalization.

21. A computer program product comprising a computer-readable storage medium, wherein the computer-readable storage medium stores a computer code which, when executed by at least one processor, causes the at least one processor to perform the method according to claim 11.
